(19) United States
(12) Patent Application Publication
(10) Pub. No.: US 2014/0067189 A1
(43) Pub. Date: Mar. 6, 2014

(54) VERIFYING COMPLETION OF A CIRCUIT TO QUALIFY A VEHICLE

(71) Applicant: James I. Smith, Papillion, NE (US)

(72) Inventor: James I. Smith, Papillion, NE (US)

(21) Appl. No.: 13/604,786

(22) Filed: Sep. 6, 2012

(51) Int. Cl. G06F 19/00

(52) U.S. Cl. 701/29.1

(57) ABSTRACT

Aspects of the disclosure relate to verifying the completion of a circuit around a vehicle. A location of an individual can be detected in relation to a vehicle within a time period to determine whether a circuit around the vehicle was properly completed by the individual. Upon determining completion of a proper circuit, the vehicle can be qualified.

### BACKGROUND

Some vehicles have large blind spots, or areas that cannot be directly observed by a driver while at the controls of a vehicle under existing driving conditions, e.g., as a driver operates a vehicle while seated at a steering wheel in a generally forward-facing direction. For example, visibility behind a driver can be reduced by pillars, headrests, passengers, cargo, and so forth. Blind spots can also occur in front of a driver as a result of, for instance, a windshield pillar, a side-view mirror, and/or an interior rear-view mirror.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Aspects of the disclosure relate to verifying the completion of a circuit around a vehicle. A location of an individual can be detected in relation to a vehicle within a time period to determine whether a circuit around the vehicle was properly completed by the individual. Upon determining completion of a proper circuit, the vehicle can be qualified.

### DRAWINGS

The Detailed Description is described with reference to the accompanying figures. The use of the same reference numbers in different instances in the description and the figures may indicate similar or identical items.

FIG. 1 is a diagrammatic illustration of a system for verifying that an operator has completed a circuit, where the circuit is performed in a clockwise direction around an environment in accordance with example implementations of the present disclosure.

FIG. 2 is a diagrammatic illustration of a system for verifying that an operator has completed a circuit around a vehicle in accordance with example implementations of the present disclosure.

FIG. 3 is a diagrammatic illustration of a system for verifying that an operator has completed a circuit in accordance with example implementations of the present disclosure.

FIG. 4 is a block diagram illustrating a system for verifying that an operator has completed a circuit, where the system can communicate with a remote monitoring authority in accordance with example implementations of the present disclosure.

FIGS. 5A and 5B are flow diagrams illustrating a method for verifying that an operator has completed a circuit in accordance with example implementations of the present disclosure.

### DETAILED DESCRIPTION

### Overview

Some vehicles have large blind spots, or areas that cannot be directly observed by a driver while at the controls of a vehicle under existing driving conditions, e.g., as a driver operates a vehicle while seated at a steering wheel in a generally forward-facing direction. For example, visibility behind a driver can be reduced by pillars, headrests, passengers, cargo, and so forth. Blind spots can also occur in front of a driver as a result of, for instance, a windshield pillar, a side-view mirror, and/or an interior rear-view mirror. Vehicles with large blind spots to the rear, including sports utility vehicles (SUVs) and vans, are becoming more prevalent in urban and suburban environments, where backing in constricted space is normal practice. Front- and back-over accidents involving injury and property damage are also occurring at an increasing rate. Furthermore, commercial freight, farm, and construction vehicles can have even larger blind spots than urban vehicles, and can be attractive to small children.

Various programs and systems have been introduced in an effort to reduce these accidents. For example, backing indicators can be used to provide an audible alert to nearby individuals that a vehicle is backing. Backing alerts can be used to sense the presence of something in the path of a backing vehicle and notify the operator to take action. Optical monitoring equipment such as cameras can also be used to provide an operator with various views external to a vehicle. However, in many instances, it may still be desirable for a vehicle operator to visually inspect conditions around a vehicle before operating the vehicle. Thus, some businesses require that employees walk around a vehicle before getting behind the wheel of the vehicle, sometimes referred to as a “360 Walk Around” or “Circle of Safety.” In this type of procedure, an employee may be required to follow an inspection routine defined by a business each time the employee exits and reenters a vehicle. For example, the employee may be instructed to place cones around a vehicle and/or walk behind the vehicle before driving away. However, it may be difficult to verify that an employee performs such a procedure.

Accordingly, techniques are described for verifying that an individual (hereinafter referred to as an “operator”) has completed a circuit around an environment within a predetermined time interval. In some instances, the environment can be the exterior and/or the interior of a vehicle, such as a fleet vehicle, and techniques in accordance with the present disclosure can be used to prevent operation of the vehicle until the circuit has been completed. For example, a fleet operator may require that a circuit is completed within a predetermined time interval before a vehicle may be started and/or operated.

In implementations, a system for verifying that an operator has completed a circuit around an environment can be included in the startup process of, for example, a vehicle. The system can be included with a vehicle by way of factory installation, as an after-market kit, and so forth. In some instances, a system can include a “Circle of Safety” procedure as part of a vehicle's startup process. Such configurations can be used in fleet (e.g., commercial) operations, personal (e.g., non-commercial) applications, and so forth. However, these particular applications are provided by way of example only and are not meant to be restrictive of the present disclosure. Thus, in other examples, techniques of the present disclosure can be used for other applications including, but not necessarily limited to: construction vehicles, farm vehicles, aircraft (e.g., personal aircraft), and so forth.

### Example Implementations

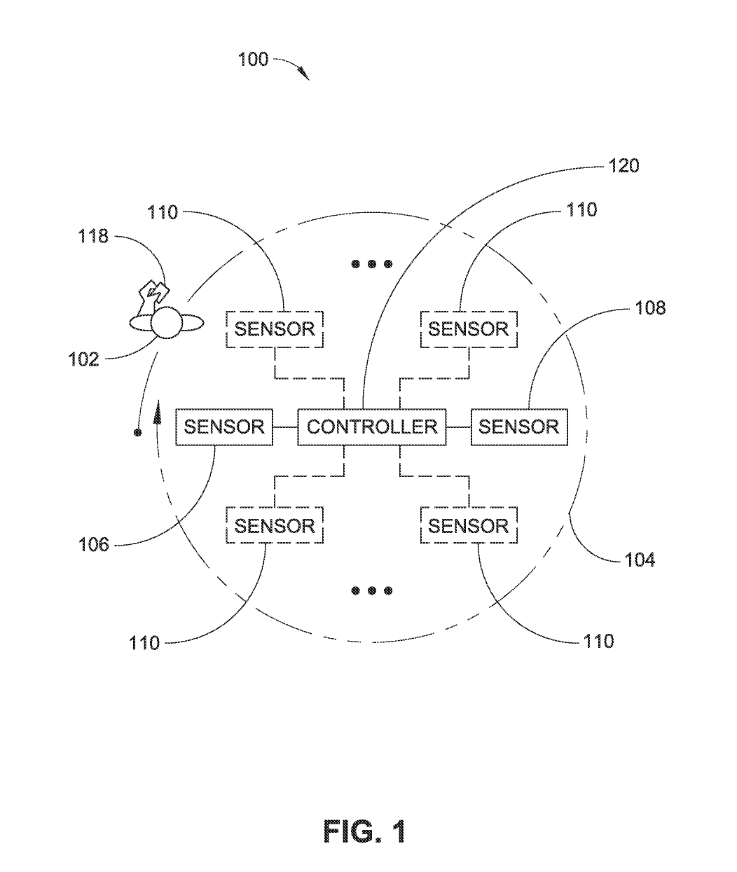

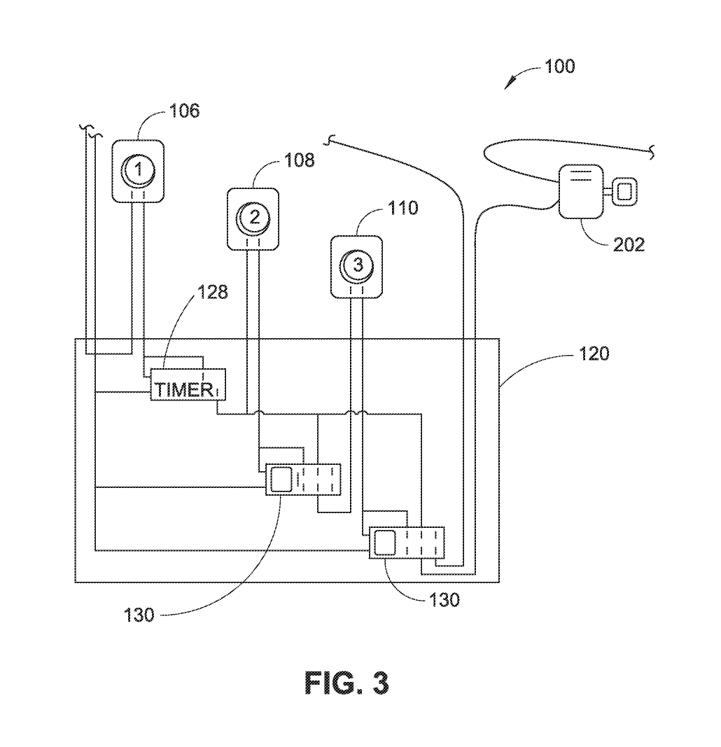

Referring generally to FIGS. 1 through 4, a system 100 for verifying that an operator 102 has completed a circuit 104 around an environment, such as the exterior and/or the interior of a vehicle 200, is described. The system 100 includes a number of sensors (e.g., a first sensor 106, a second sensor 108, and possibly one or more additional sensors 110) configured to determine the presence of the operator 102 with respect to a number of areas in an environment, such as a first area 112, a second area 114, and possibly one or more additional areas 116. In some instances, the first area 112, the second area 114, and/or additional areas 116 can be located external to the vehicle 200. For example, an area 112, 114, 116 can comprise an area adjacent to the exterior of the vehicle 200 corresponding to a hatch for a gas container. In other instances, the first area 112, the second area 114, and/or additional areas 116 can be located internal to the vehicle 200. For instance, an area 112, 114, 116 can comprise an area adjacent to an interior wall of a tractor trailer. In this type of configuration, the operator 102 may be required to inspect cargo (e.g., to verify that freight is sufficiently secured within the vehicle 200, to inspect hazardous material transported using the vehicle 200, and so on).

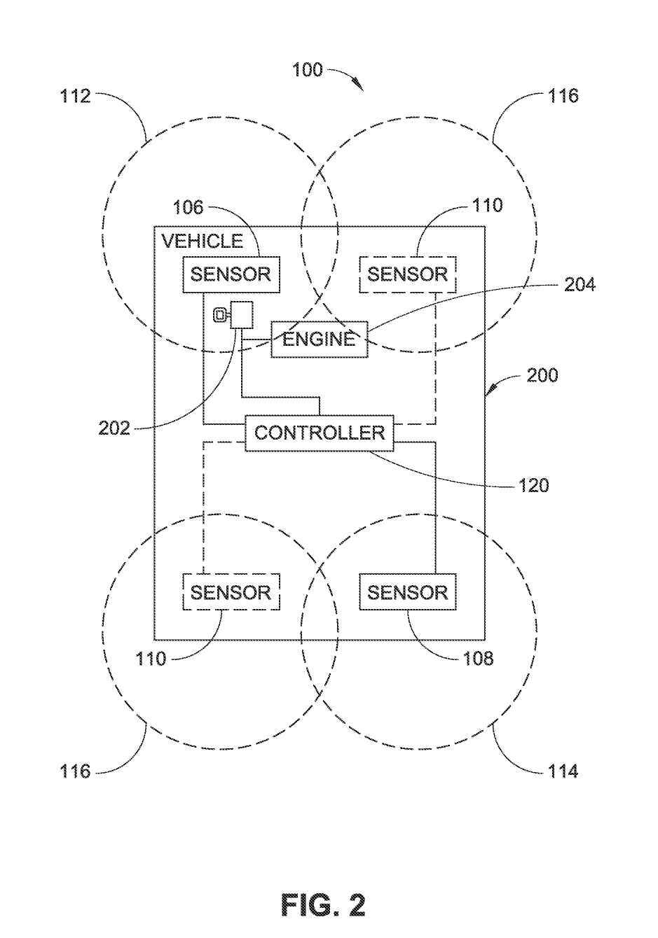

As illustrated in FIG. 2, the first sensor 106 can be configured to determine the presence and/or the absence of the operator 102 with respect to the first area 112 (e.g., where the first area 112 is associated with the exterior and/or the interior of the vehicle 200). Similarly, the second sensor 108 can be configured to determine the presence and/or the absence of the operator 102 with respect to the second area 114 (e.g., where the second area 114 is associated with the exterior and/or the interior of the vehicle 200). Further, one or more additional sensors 110 can be configured to determine the presence and/or the absence of the operator 102 with respect to additional areas 116 (e.g., where the additional areas 116 are associated with the exterior and/or the interior of the vehicle 200). In this manner, the first sensor 106 can be used to provide an indication of the presence of the operator 102 with respect to the first area 112; the second sensor 108 can be used to provide an indication of the presence of the operator 102 with respect to the second area 114; and so forth.

It should be noted that for the purposes of the present disclosure, determining the absence of the operator 102 with respect to a particular area or a number of areas can be used to determine the presence of the operator 102 with respect to a different area. For instance, in a closed environment where the operator 102 can be located in one of a finite number of areas, such as a garage, the absence of the operator in one or more areas can be associated with the presence of the operator 102 in another area.

The first sensor 106, the second sensor 108, and possibly the additional sensors 110 can use various sensing techniques to determine the presence and/or the absence of the operator 102 in a particular environment, such as with respect to the exterior and/or the interior of the vehicle 200. For example, in some instances, one or more sensors can be implemented using a proximity sensor to indicate the presence and/or the absence of a mobile device 118, such as a key fob, a smart key, and so forth. In a particular example, a sensor can be implemented using a radio frequency identification (RFID) signal receiving device configured to indicate the proximity of an RFID tag in a key fob that can be held in a pocket, a hand, and so forth. For example, when an “unlock” button on the mobile device 118 is pressed, the parking lights of the vehicle 200 can be activated which, in turn, can activate sequentially located RFID devices connected to the parking lights. However, this implementation is provided by way of example only and is not meant to be restrictive of the present disclosure. Thus, in other implementations, the mobile device 118 can be implemented using a variety of instrumentation, including, but not necessarily limited to: a mobile phone; a position-determining device; a hand-held portable computer; a Personal Digital Assistant (PDA); a multimedia device; a device worn by the operator 102 (e.g., a watch or a badge); and so forth.

Further, a sensor configured using RFID technology is provided by way of example only and is not meant to be restrictive of the present disclosure. Thus, one or more sensors can be implemented using an image capture device (e.g., a camera), a photoelectric sensor, a sonic sensor (e.g., an ultrasonic sensor), and/or another type of sensor. One or more of the sensors can be configured to sense the presence and/or the absence of the operator 102 by determining the presence and/or the absence of the operator 102 between two sensor portions, determining a distance between the operator 102 and a sensor, determining contact by the operator 102 with a sensor, and so forth. In some instances, one or more sensors can comprise equipment included with the vehicle 200, such as the ignition of the vehicle 200. In this configuration, the presence and/or the absence of the operator at the first area 112 can be determined by activation of the ignition of the vehicle 200.

The first sensor 106, the second sensor 108, and/or additional sensors 110 can be communicatively coupled with a controller 120. In implementations, each sensor is configured to provide the controller 120 with an indication of the presence of the operator 102 with respect to an area associated with the corresponding sensor. The controller 120 is configured to assess communication from the sensors to ensure proper sequence and timing of movement by the operator 102. In some instances, the controller 120 can allow and/or prevent operation of, for example, the vehicle 200 based upon communication with the sensors. For the purposes of the present disclosure, providing an indication of the presence of the operator 102 with respect to an area associated with a sensor can include providing information regarding the operator 102 and/or information associated with the presence of the operator within a particular area. For example, such indication can include, but is not necessarily limited to: a duration of time the operator 102 spends in a particular area, an amount of movement the operator 102 engages in while in a particular area, the identity of the operator 102 (e.g., a badge number), and so forth. For instance, an operator may be required to check the air pressure of a tire located in a particular area, and the amount of time the operator is required to spend at a location associated with the tire can be specified accordingly.

As illustrated in FIG. 1, the controller 120 can use indications received from one or more of the sensors to verify that the operator 102 has completed a circuit 104 around an environment. With reference to FIG. 2, the environment can be the exterior of the vehicle 200. For example, a number of sensors can be located at various locations near the exterior of the vehicle 200. However, the exterior of the vehicle 200 is provided by way of example only and is not meant to be restrictive of the present disclosure. Thus, in other instances, sensors can be located at various locations for sensing the operator 102 in positions in the interior of the vehicle 200. Further, the vehicle 200 is provided by way of example only, and an environment can also be external and/or internal to a structure, such as a garage, and so forth.

In implementations, the controller 120 associates a time with each indication received from the various sensors. For example, when a first indication is received from the first sensor 106, the first indication is associated with a time that the first indication is received (or transmitted), e.g., using a timestamp. When a second indication is subsequently received from the second sensor 108, the second indication is associated with a time (e.g., a timestamp) that the second indication is received (or transmitted), and so forth. Then, when another indication is received from a sensor indicating that the circuit 104 has been completed (e.g., from the first sensor 106 and/or from another sensor associated with the first area 112), this indication is also associated with a time of reception (or transmission), e.g., using another timestamp. For example, in an instance where two sensors are used with the system 100, a third indication can be received from the first sensor 106 and associated with a particular time. In an instance where four sensors are used with the system 100 (e.g., as illustrated in FIG. 2), a fifth indication can be received from the first sensor 106 and associated with a particular time.

It should be noted that, for the purposes of the present disclosure, the term “first sensor” can be used to describe a sensor positioned at or near the beginning of the circuit 104 that the operator 102 performs. Thus, terms such as “first sensor,” “second sensor,” and so forth are not meant to be restrictive of the position of a sensor with respect to a particular location, such as a particular position on the vehicle 200. For example, in an instance where the operator 102 starts the circuit 104 at or near the driver-side door of the vehicle 200, the first sensor 106 can comprise a sensor positioned proximate to a front driver-side parking light (e.g., as illustrated in FIG. 2). In an instance where the operator 102 starts a circuit at or near the rear of the vehicle 200, a first sensor can comprise a sensor positioned proximate to a rear passenger-side light, and so forth. Accordingly, terms such as “second sensor,” “additional sensor,” and so on can be used to refer to sensors as they are sequentially encountered during completion of the circuit 104, and do not necessarily indicate or limit a sensor to a particular positional orientation.

By determining a time difference between the first time and the last time associated with the circuit 104 (e.g., the third time as described in the example above), the controller 120 can verify the operator 102 has completed the circuit 104 within a specific timeframe. In implementations, when the time difference is less than, or at least substantially equal to, a predetermined time interval, the controller 120 can verify completion of the circuit 104 by the operator 102 within the predetermined time interval. However, verification of the circuit 104 is not necessarily limited to completion within a specific timeframe. For example, the operator 102 can also be required to move in a particular pattern to complete the circuit 104. Thus, in some instances, the system 100 can verify that the presence and/or the absence of the operator is indicated in a particular sequence (e.g., in a clockwise manner with respect to a group of sensors, a counterclockwise manner with respect to a group of sensors, and so forth).

In some instances, the controller 120 is also operatively coupled with the vehicle 200 and configured to qualify the vehicle 200 (e.g., to control one or more operations of the vehicle 200). For example, the controller 120 can be coupled with a starter 202 of the vehicle 200 and used to allow and/or prevent starting of the vehicle's drive assembly (e.g., operation of an engine 204). In some instances, the controller 120 can be implemented using a kill switch configured to deactivate the engine 204. In other instances, the controller 120 can be implemented to selectively allow activation of the starter 202. In implementations, the controller 120 can also be operatively coupled with other components of the vehicle 200 (e.g., to control operation of the vehicle's horn, brakes, parking lights, and so forth). For example, the controller 120 can be configured to operate the vehicle's brakes to inhibit the vehicle from moving. In some instances, operation of the vehicle 200 can be allowed and/or prevented based upon other conditions in addition to completion (or non-completion) of the circuit 104. For example, operation of the vehicle 200 can be prevented until the operator 102 enters a cabin, buckles a seatbelt, and so forth. Further, it should be noted that the system 100 and/or the vehicle 200 can include a bypass process and/or monitor to allow starting of the vehicle 200 in case of a power failure, emergency condition, and so forth, which can prevent the operator 102 from performing the circuit 104.

In an instance where the operator 102 determines not to use a particular protocol that involves completing the circuit 104, the system 100 and/or the vehicle 200 can initiate a variety of actions which can be defined by, for example, a fleet operator. Some of these actions include, but are not necessarily limited to: a prolonged sounding of the vehicle's horn, communication of the bypass operation to a fleet operator (e.g., using GPS, a smart device, and so forth), a visible signal (e.g., an indicator light) that is reset by a fleet operator, or no action.

The controller 120 can include a processor 122, a network interface 124, and a memory 126. The processor 122 provides processing functionality for the controller 120 and can include any number of processors, micro-controllers, or other processing systems and resident or external memory for storing data and other information accessed or generated by the controller 120. The processor 122 can execute one or more software programs that implement techniques described herein. The processor 122 is not limited by the materials from which it is formed or the processing mechanisms employed therein and, as such, can be implemented via semiconductor(s) and/or transistors (e.g., using electronic integrated circuit (IC) components), and so forth. For example, the controller 120 can be implemented using an electronic timer 128 and one or more additional timers 130. In this type of configuration, performance of the circuit 104 is not necessarily recorded or logged by the system 100.

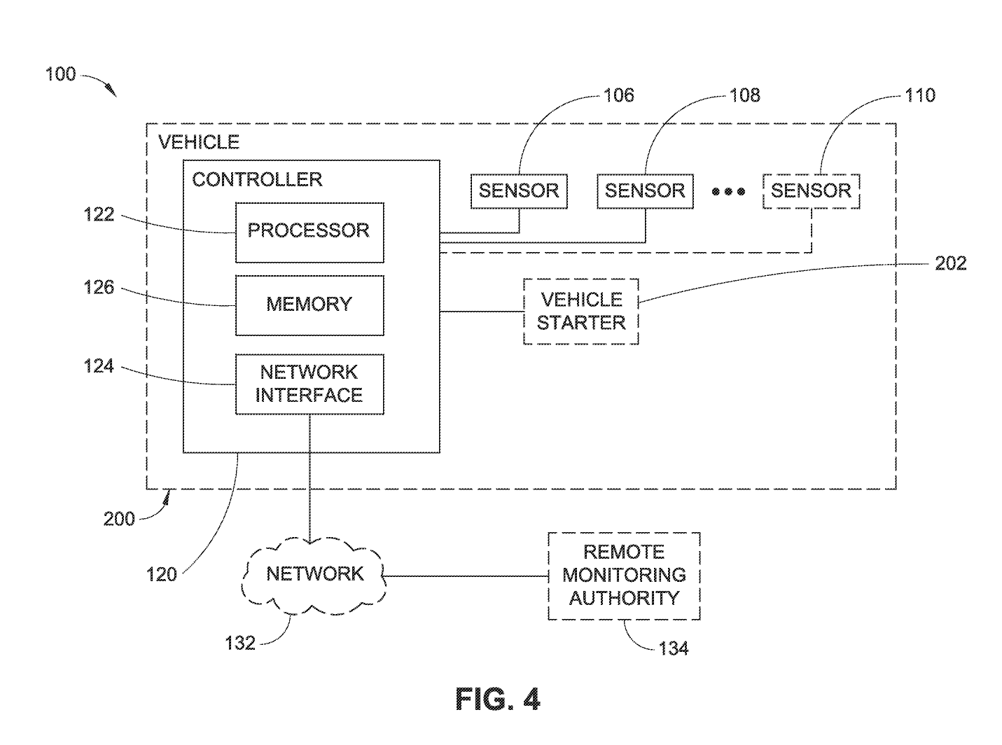

The network interface 124 is operatively configured to communicate with components of the system 100. For example, the network interface 124 can be configured to transmit data for storage in the system 100, retrieve data from storage in the system 100, and so forth. The network interface 124 is also communicatively coupled with the processor 122 (e.g., to facilitate data transfer between components of the system 100 and the processor 122). The network interface 124 provides functionality to enable the system 100 to communicate using one or more networks. In implementations, the network interface 124 can include a variety of components including, but not necessarily limited to: cellular telephone transceivers, modems, routers, wireless access points, and so forth, and associated software employed by these components (e.g., drivers, configuration software, and so on). In FIG. 4, the network interface 124 is illustrated as a component of the system 100. However, one or more components of the network interface 124 can be implemented as external components communicatively coupled to the system 100 via a wired and/or wireless connection.

The network interface 124 can be configured to connect to a network 132. The network 132 can assume a wide variety of configurations. For example, the network 132 can comprise, but is not necessarily limited to: a wide-area cellular telephone network, such as a 3G cellular network, a 4G cellular network, or a global system for mobile communications (GSM) network; a wireless computer communications network, such as a WiFi network (e.g., a wireless local area network (WLAN) operated using IEEE 802.11 network standards); an internet; the Internet; a wide area network (WAN); a local area network (LAN); a personal area network (PAN) (e.g., a wireless personal area network (WPAN) operated using IEEE 802.15 network standards); a public telephone network; an extranet; an intranet; and so on. However, this list is provided by way of example only and is not meant to be restrictive of the present disclosure. Further, the network 132 can be configured to include a single network or multiple networks across different access points. The system 100 can also comprise and/or connect to one or more input/output (I/O) devices (e.g., via the network interface 124) including, but not necessarily limited to: a display, a mouse, a touchpad, a keyboard, and so on.

In implementations, the network interface 124 can be used to communicatively couple the system 100 to one or more external entities. For example, the network interface 124 can be used to connect the system 100 to a remote monitoring authority 134, such as a fleet operator, and so forth. Information regarding whether the operator 102 has completed a circuit 104 around an environment (e.g., the exterior and/or the interior of the vehicle 200) can be transmitted to the remote monitoring authority 134 at various intervals. For example, such information can be transmitted each time a circuit 104 is completed (or not completed), each time a vehicle 200 is stopped and restarted, periodically (e.g., hourly, daily, and so forth), at random or pseudorandom time intervals, and so on. The transmission can be requested and/or scheduled by the remote monitoring authority 134, by the operator 102, and so forth.

Additional information can be collected and associated with completion (or non-completion) of a circuit 104 and/or transmitted to the remote monitoring authority 134. The additional information can include, but is not necessarily limited to: positional information (e.g., as collected by a position-determining device, such as a global positioning system (GPS) device), information regarding a time when a circuit 104 is completed (or not completed), information regarding a time interval during which a circuit 104 is completed, information regarding one or more environmental conditions (e.g., a moisture level, a noise level, an ambient light level), and so on. In implementations, the remote monitoring authority 134 can qualify the vehicle 200 based upon information received using the network interface 124. Further, the controller 120 can allow and/or prevent operation of the vehicle 200 based upon information received from the remote monitoring authority 134. The remote monitoring authority 134 can qualify a vehicle 200 based upon completion of the circuit 104 and/or based upon other information which can include, but is not necessarily limited to: the identity of the operator 102, an operator's driving performance record, and so forth.

The memory 126 is an example of tangible computer-readable storage medium that provides storage functionality to store various data associated with operation of the controller 120, such as software programs and/or code segments, or other data to instruct the processor 122, and possibly other components of the controller 120, to perform the steps described herein. Although a single memory 126 is shown, a wide variety of types and combinations of memory can be employed. The memory 126 can be integral with the processor 122, can comprise stand-alone memory, or can be a combination of both. The memory 126 can include, but is not necessarily limited to: removable and non-removable memory components, such as random-access memory (RAM), read-only memory (ROM), flash memory (e.g., a secure digital (SD) memory card, a mini-SD memory card, and/or a micro-SD memory card), magnetic memory, optical memory, universal serial bus (USB) memory devices, and so forth. In embodiments, the memory 126 can include removable integrated circuit card (ICC) memory, such as memory provided by a subscriber identity module (SIM) card, a universal subscriber identity module (USIM) card, a universal integrated circuit card (UICC), and so on.

### Example Process

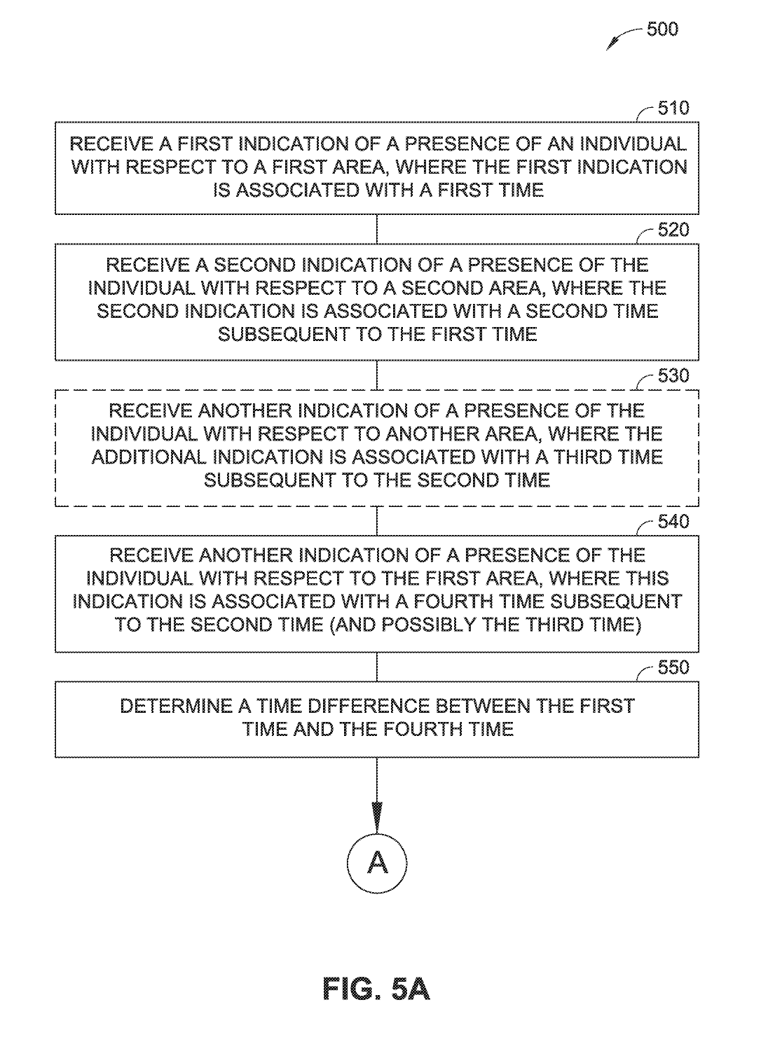

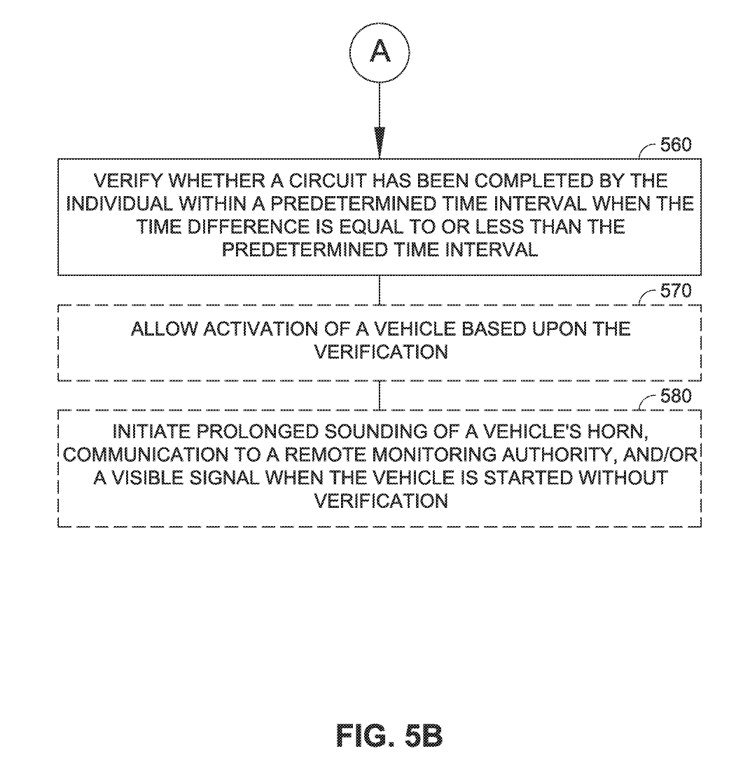

Referring now to FIGS. 5A and 5B, example techniques are described for verifying that an individual has completed a circuit around an environment within a predetermined time interval. FIGS. 5A and 5B depict a process 500, in an example implementation, for verifying completion by an individual of a circuit around an environment, such as the exterior and/or the interior of a vehicle, e.g., as illustrated in FIGS. 1 through 4 and described above.

In the process 500 illustrated, a first indication of a presence of an individual with respect to a first area is received. The first indication is associated with a first time (Block 510). Then, a second indication of a presence of the individual with respect to a second area is received. The second indication is associated with a second time subsequent to the first time (Block 520). In some instances, another indication of a presence of the individual with respect to another area is received. The additional indication is associated with a third time subsequent to the second time (Block 530). Next, another indication of a presence of the individual with respect to the first area is received. This indication is associated with a fourth time subsequent to the second time (and possibly the third time) (Block 540).

Then, a time difference is determined between the first time and the fourth time (Block 550). Next, whether a circuit has been completed by the individual within a predetermined time interval is verified when the time difference is equal to or less than a predetermined time interval (Block 560). The verification can be used to qualify a vehicle, such as the vehicle 200 described in FIGS. 2 through 4. In implementations where more than two sensors are used to sense the presence and/or the absence of an operator, verification of whether a circuit has been completed can include determining whether the circuit has been properly completed in an appropriate sequence. For example, when an indication is received and associated with a third time (e.g., as described in Block 530), verifying that a circuit has been properly completed can include determining that the third time is subsequent to the second time and prior to the fourth time. In some instances, activation of a vehicle is allowed based upon the verification (Block 570), e.g., when the vehicle has been qualified, as described above. In implementations, one or more of a prolonged sounding of a vehicle's horn, communication to a remote monitoring authority, and/or a visible signal can be initiated when the vehicle is started without verification (Block 580).

### Conclusion

Although the subject matter has been described in language specific to structural features and/or process operations, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for verifying completion of a circuit with respect to a vehicle for qualifying the vehicle, the computer-implemented method comprising:
receiving a first indication of a presence of an individual with respect to a first area associated with the vehicle, the first indication associated with a first time;
receiving a second indication of a presence of the individual with respect to a second area associated with a vehicle, the second indication associated with a second time subsequent to the first time;
receiving a third indication of a presence of the individual with respect to the first area, the third indication associated with a third time subsequent to the second time; and
causing a processor to determine a time difference between the first time and the third time and verify whether a circuit has been completed by the individual within a predetermined time interval to qualify the vehicle when the time difference is at least one of substantially equal to or less than the predetermined time interval.

2. The computer-implemented method as recited in claim 1, further comprising receiving a fourth indication of a presence of the individual with respect to a third area associated with the vehicle and positioned generally between the first area and the second area along the circuit, the fourth indication associated with a fourth time subsequent to the first time and prior to the second time.

3. The computer-implemented method as recited in claim 1, wherein the individual comprises an operator of the vehicle, the first area comprises a first area associated with at least one of an exterior or an interior of the vehicle, and the second area comprises a second area associated with the at least one of the exterior or the interior of the vehicle.

4. The computer-implemented method as recited in claim 1, wherein at least one of the first indication, the second indication, or the third indication is received as the result of detecting a mobile device associated with the individual.

5. The computer-implemented method as recited in claim 4, wherein the mobile device comprises a radio frequency identification (RFID) tag.

6. The computer-implemented method as recited in claim 1, further comprising allowing activation of a vehicle based upon the verification of whether the circuit has been completed by the individual within the predetermined time interval.

7. The computer-implemented method as recited in claim 1, further comprising initiating at least one of a prolonged sounding of a vehicle's horn, communication to a remote monitoring authority, or a visible signal when the vehicle is started without verification of whether the circuit has been completed by the individual within the predetermined time interval.

8. A computer-readable storage medium having computer executable instructions for verifying completion of a circuit with respect to a vehicle for qualifying the vehicle, the computer executable instructions comprising:
receiving a first indication of a presence of an individual with respect to a first area associated with a vehicle, the first indication associated with a first time;
receiving a second indication of a presence of the individual with respect to a second area associated with the vehicle, the second indication associated with a second time subsequent to the first time;
receiving a third indication of a presence of the individual with respect to the first area, the third indication associated with a third time subsequent to the second time;
determining a time difference between the first time and the third time; and
verifying whether a circuit has been completed by the individual within a predetermined time interval to qualify the vehicle when the time difference is at least one of substantially equal to or less than the predetermined time interval.

9. The computer-readable storage medium as recited in claim 8, wherein the computer executable instructions further comprise receiving a fourth indication of a presence of the individual with respect to a third area associated with the vehicle and positioned generally between the first area and the second area along the circuit, the fourth indication associated with a fourth time subsequent to the first time and prior to the second time.

10. The computer-readable storage medium as recited in claim 8, wherein the individual comprises an operator of the vehicle, the first area comprises a first area associated with at least one of an exterior or an interior of the vehicle, and the second area comprises a second area associated with the at least one of the exterior or the interior of the vehicle.

11. The computer-readable storage medium as recited in claim 8, wherein at least one of the first indication, the second indication, or the third indication is received as the result of detecting a mobile device associated with the individual.

12. The computer-readable storage medium as recited in claim 11, wherein the mobile device comprises a radio frequency identification (RFID) tag.

13. The computer-readable storage medium as recited in claim 8, wherein the computer executable instructions further comprise allowing activation of a vehicle based upon the verification of whether the circuit has been completed by the individual within the predetermined time interval.

14. The computer-readable storage medium as recited in claim 8, wherein the computer executable instructions further comprise initiating at least one of a prolonged sounding of a vehicle's horn, communication to a remote monitoring authority, or a visible signal when the vehicle is started without verification of whether the circuit has been completed by the individual within the predetermined time interval.

15. A system for verifying completion of a circuit with respect to a vehicle for qualifying the vehicle, the system comprising:
a first sensor configured to determine at least one of a presence or an absence of an individual with respect to a first area associated with a vehicle;
a second sensor configured to determine at least one of a presence or an absence of the individual with respect to a second area associated with the vehicle;
a processor communicatively coupled with the first sensor for receiving an indication of the at least one of the presence or the absence of the individual with respect to the first area, the processor communicatively coupled with the second sensor for receiving an indication of the at least one of the presence or the absence of the individual with respect to the second area; and
a memory having computer executable instructions stored thereon, the computer executable instructions configured for execution by the processor to:
associate a time with the indication of the at least one of the presence or the absence of the individual with respect to the first area received from the first sensor;
associate a time with the indication of the at least one of the presence or the absence of the individual with respect to the second area received from the second sensor; and
verify whether a circuit has been completed by the individual within a predetermined time interval to qualify the vehicle when a first time is associated with a presence of the individual with respect to the first area, a second time subsequent to the first time is associated with a presence of the individual with respect to the second area, a third time subsequent to the second time is associated with a presence of the individual with respect to the first area, and a time difference between the first time and the third time is at least one of substantially equal to or less than the predetermined time interval.

16. The system as recited in claim 15, further comprising a third sensor configured to determine at least one of a presence or an absence of the individual with respect to a third area associated with the vehicle and positioned generally between the first area and the second area along the circuit, the processor communicatively coupled with the third sensor for receiving an indication of the at least one of the presence or the absence of the individual with respect to the third area.

17. The system as recited in claim 15, wherein the individual comprises an operator of the vehicle, the first area comprises a first area associated with at least one of an exterior or an interior of the vehicle, and the second area comprises a second area associated with the at least one of the exterior or the interior of the vehicle.

18. The system as recited in claim 15, wherein at least one of the first sensor or the second sensor is configured to sense a mobile device associated with the individual to determine the at least one of the presence or the absence of the individual.

19. The system as recited in claim 18, wherein the mobile device comprises a radio frequency identification (RFID) tag.

20. The system as recited in claim 15, wherein the system is configured to couple with a starter of a vehicle, and the computer executable instructions are further configured for execution by the processor to allow activation of the vehicle based upon the verification of whether the circuit has been completed by the individual within the predetermined time interval.
